(19) United States
(12) Patent Application Publication
(10) Pub. No.: US 2019/0210399 A1
(43) Pub. Date: Jul. 11, 2019

(54) Mass-Producible, Forgery-Proof Marking, Particularly A Forgery-Proof Label, Method For Mass Production Of Such A Marking, And Method For Identifying Such A Marking

(71) Applicant: MOBO Etiketten GmbH, Villingen-Schwenningen (DE)

(72) Inventor: Richard Motz, Rietheim-Weilheim (DE)

(73) Assignee: MOBO Etiketten GmbH, Villingen-Schwenningen (DE)

(21) Appl. No.: 16/334,266

(22) PCT Filed: Sep. 15, 2017
(86) PCT No.: PCT/EP2017/073360

§ 371 Date: Mar. 18, 2019

(30) Foreign Application Priority Data
Sep. 16, 2016 (DE) 10 2016 011 170.4

(51) Int. Cl. B42D 25/378; B42D 25/405; G09F 3/00; B41J 2/21

(52) U.S. Cl. CPC B42D 25/378; B41J 2/21; G09F 3/0292; B42D 25/405

(57) ABSTRACT

The application relates to a forgery-proof object, particularly a forgery-proof label having, applied to a first main surface of the object, a multicolored imprint of at least two coloring compounds each of which comprises a different color and which, in a random manner, both at least partially run into one another and are smudged or blown together. The coloring compounds are preferably in the form of pigment droplets, and said running and smudging is brought about by a corresponding air nozzle which acts on the coloring compounds applied to the object, before they dry.

The invention relates to a mass-producible, forgery-proof marking, particularly a forgery-proof label, method for mass production of such a marking, and method for identifying such a marking.

Such forgery-proof markings, which are regularly printed on an object, such as a sheet of paper or film, are known, for example, from DE 10 2012 220 701 A1. A security feature including two directly adjacent areas is applied onto a substrate, such as an ID card. Colored fibers of various types are located in these areas. The two types differ in luminescent substances contained therein, which can be made visible by illuminating the security feature with UV radiation. Colored fibers result in a color effect inside the partial areas, which is caused by luminescent colors of the two fiber types. A transitional area in which the two areas adjoin one another, includes both colored fibers of the one type and colored fibers of the other type. Since the colored fibers of the one type are also partially spread into the second area, where primarily the colored fibers of the other type are located, a color effect results which is characterized by a color progression from the luminescent color of the colored fibers of the first type to the luminescent color of the colored fibers of the other type. If, for example, colored fibers of the one type are used that contain a green luminescent substance and colored fibers of the other type that contain a red luminescent substance, a color progression structure is obtained between a green surface in the one area and a red surface in the other area. The color progression structure in which mixed colors of the colored fiber types are created is formed in the transitional area between the two areas. Since the two colors are created by luminescence, an additive color mixture is obtained, for example in accordance with the RGB color space. The ID card must be illuminated with UV radiation to make this security feature visible.

Other forgery-proof labels are disclosed, for example, in DE 10 2014 119 175 A1. There, various types of security features are incorporated into a paper stock which is subsequently processed into labels.

Another forgery-proof label is disclosed in DE 11 2007 001 726 B4. This document also envisages a random distribution of objects in a substrate or a random mark which is attached to the product or packaging or incorporated therein. In addition to a cryptogram, an electronic memory element is provided which may store data regarding the marker.

Document DE 2015 102 994 A1 only focuses on a security label in which a one or multidimensional machine-readable code and a hologram-based security label element are applied to the label.

Document DE 2014 007 976 A1 focuses on a security label in which the security label changes dynamically over time.

Document DE 2006 019 248 A1 discloses marking points which are arranged to partially overlap on a base. It remains open whether these are color points in different colors.

In addition, document DE 39 06 122 A1 discloses a method for producing random markings and their use for determining and checking connection points of containers, housings, or facilities. Randomly distributed markings are applied to a carrier material, which itself can be a container or housing. For this purpose, a plastic injection-molding machine which produces the housing part is equipped with two feeding units, and the one feeding unit feeds it a granulate of another color than the other feeding unit. If two granulates are selected whose colors are in sharp contrast and do not merge very well due to their structure, a multitude of high-contrast markings of different values is obtained, which are randomly distributed and vary from one injection-molded part to the other. It is a problem of prior art forgery-proof markings that these can only produced with a great effort and are therefore suitable to a limited extent only for effectively protecting mass products such as textiles, cosmetics, foods, or the like from product piracy.

This is where the present invention comes into play. It is the object of the present invention to provide a mass-producible and thus easily industrially producible forgery-proof marking, and particularly a forgery-proof label, and a method for its production, which cannot be reproduced easily and without complicated means. It is another object of the present invention to provide a method for identifying such a mass-produced, forgery-proof marking.

Such a forgery-proof marking is made possible with the features of claim 1. The basic idea of the invention is to apply a colored print to a main surface of an object, which print comprises at least two, preferably three or more colored droplets, which may be ink droplets, for example. The coloring compounds each have a different color and have at least partially and randomly run into each other and are randomly distributed, particularly blown or smudged or swirled, such that the marking has a different brightness profile, at least in sections thereof.

In one embodiment of the invention, it is sufficient to use a single or multiple ink droplets that have each the same color. These ink droplets or this single ink droplet must also be distributed randomly, particularly blown, smudged, or swirled, such that the ink droplets distributed or mixed in this manner have different brightness profiles.

The method according to the invention for producing such a forgery-proof object is characterized by the following process steps:
Providing an object having at least one main surface,
Applying at least one, preferably two, coloring compounds in the form of ink droplets to the main surface of the object,
Distributing and/or mixing the applied color drop(s) as long as the coloring compounds have not dried, preferably using an air nozzle,
Drying the imprint.

Applying and distributing and/or mixing are performed by machines.

The decisive advantage of such a forgery-proof imprint on an object is that tit can easily be identified as an original label and distinguished from a forgery using very simple means. All it takes is an optical device, such as a mobile terminal, having a camera function, such as a smartphone, tablet, virtual reality (VR) glasses or the like with which the imprint is optically detected. The original, even at the largest zoom setting, will not show any striation of the multicolor imprint, and in addition will reveal very highly detailed specifics. But if the label is forged by simply copying the original label using a conventional copier, the forged label will be characterized in that, when said marking is viewed under high magnification, a striation will become clearly visible. Such a striation is inevitable in reproduced labels, such as using a color copier.

This is because striation is absolutely necessary when using today's common copying and printing methods for rendering blended colors and color progressions for individual colors to achieve semitones, that is, color blends, and to achieve color progressions, that is, colors that progress from dark to bright, for example using a bit map of about 1000 to 2000 ppcm (pixels per cm). Compared to electronic cameras, as are used in mobile terminals such as smartphones, tablets, or recently also in VR glasses, this pixel resolution is much lower than the pixel resolution of the camera. Conventional cameras of smartphones have pixel values of more than 10 million, that is, 10 million ppcm. The present invention utilizes this fact for a method to verify if a marking is a forgery-proof marking according to the present invention or a forged marking, that is, a copied marking. The mobile terminal can easily be used to photograph the marking to be verified. Then this image is viewed under a high magnification using the zoom function of the camera of the smartphone. If this high magnification reveals a striation of the photographed marking, this marking is a forgery. But if such striation is not visible or detected even at the highest zoom, the marking is an original marking according to the invention, wherein the marking photographed using the mobile terminal must match an original marking previously stored in a database.

The method for identifying an original marking thus includes the following process steps:
Optical detection of the marking (10) and electronically storing it in a database,
Optical detection of a marking to be identified using a mobile terminal and electronically storing an image of that marking,
Comparing the image captured by the mobile terminal to the marking (10) stored in the database,
Determining that an original marking (10) was captured, if
   a) the image captured using the mobile terminal does not comprise copy-related striation, and
   b) matches or largely matches the image stored in the database, and
Determining that a forged marking is present if at least one of a) and b) is not met. The marking according to the invention, the production method, and the method for identifying such a marking are thus characterized in that no expensive special inks are needed for implementation and that an end customer can easily check if a marking is genuine without having to use expensive readers. The rationale of the invention is the production of a special color imprint which will hereinafter be called “fingerprint”, and detection of such a marking.

In the simplest case, any easily obtainable ink can be used to implement the marking. It is preferred to use so-called pigmented inks for this purpose. The preferred colors used are the solid colors yellow, blue, and/or red. These colors applied as a single ink droplet onto a surface of an object and then intermixed in a suitable manner or at least smudged such that color progressions are created. It is important for the present invention that the ink droplet(s) applied to a main surface of an object are applied in supersaturated form, such that this one or these multiple ink droplet(s) will be intermixed or distributed in a subsequent processing step. Although it is preferred to use one or multiple ink droplets, any other coloring compounds may be used according to the invention in supersaturated form.

This “fingerprint” can be created as follows:

As mentioned above, preferably two, three or more droplets of pigmented inks of different colors (e.g. red, yellow, blue) are arbitrarily applied to the label, which may be a print substrate or a paper. One or multiple of these pigmented inks may include special properties, e.g. fluorescent color particles or glitter particles. These ink droplets are applied to the label carrier next to each other or partially overlapping. Then these highly viscous ink droplets are distributed, advantageously using an air nozzle and high air pressure. The air nozzle and/or the label may also rotate to achieve a particularly good distribution of the ink droplets. A unique pattern of spatters and color progressions in which the ink droplets intermix at least in partial areas, which pattern can no longer be identically reproduced, is created by swirling. This produces so-called semitones.

Instead of distributing and mixing each of these coloring compounds using an air nozzle, the same can also be achieved by suitably vibrating, pivoting, or rotating the label. In addition, vibration can be caused by exposing the ink droplets to ultrasound.

In a further developed embodiment of the invention other data in addition to the “fingerprint” is added to the label, preferably in coded form. This may be a suitable time stamp and other information (e.g. manufacturer, item code, etc.). This code may be a barcode, a QR code, a data matrix code, or the like. Expediently, this additional code or additional coding is printed onto the same main surface of the label or object to protect from forgery as the aforementioned “fingerprint.”

The aforementioned “fingerprint” advantageously cannot be reproduced in large quantities using machinery, and thus cannot be favorably reproduced. This is due, on the one hand, to the tiny spatters of ink that are created when the air nozzle swirls the ink droplets or coloring compounds, respectively. Such tiny spatters of ink are difficult to reproduce and can hardly be printed in large quantities. Particularly the color progressions and color mixes of the ink droplets cannot be reproduced in large quantities without striation, as mentioned above.

If we assume, for example, that the ink droplets applied to the label are blue and yellow, intermixing and swirling these two ink droplets will result in a more or less bright or dark green in the overlapping mixing area. This green is printed without any striation across the surface of the original label. To produce or reproduce this green on a printer or copier would require applying the colors blue and yellow to the label. A printer or copier can do this only with a striation of the blue and yellow color imprints. This striation can easily be detected later by a commercially available smartphone, if the forged label is viewed or photographed at a high zoom setting.

The forgery-proof design of an object, such as a label, and the associated method for producing a respective imprint onto such an object is substantially based on the finding that conventional printing methods for producing mixed colors require a striation when printing and superimposing the base colors to produce a mixed color. Printmaking, e.g. the so-called four-color printing, uses the three base colors cyan, which corresponds to a Helio fast blue hue, magenta, which corresponds to a purple hue, and yellow, which corresponds to yellow. These three base colors, yellow, magenta, and cyan, would even suffice to produce the color black, if overprinted accordingly. The physically determined shape and position of the spectrum of technically and economically available color pigments however prevent printing deep black using these three ideal colors mentioned. This is why four-color printing also uses the color black. The other colors are achieved by mixing. But this mixing needs the aforementioned striation in conventional printing and the superimposing of the individual striated colors mentioned above. The present invention utilizes precisely this phenomenon to distinguish an original object from a forged object, such as an original label from a forged label.

If only one or multiple ink droplets of a single color are used for producing a forgery-proof marking according to the present invention, it must be ensured that the ink droplet(s), in the distribution step according to the invention, is/are distributed after application in supersaturated form in such a manner that the finished marking shows a color progression from bright to dark. Such a color progression from bright to dark can likewise only be reproduced using conventional printing methods if such marking is printed with a striation. As explained above, such a striation can once again be easily detected using a mobile terminal.

In principle, it is possible to represent color progressions almost without striation when using highly sophisticated printing methods at a very high resolution. However, these methods are so complicated and expensive that they are not suitable for cheap mass production of forged labels.

In another embodiment of the invention, the color imprints and therefore the fingerprints can be made even more secure if fluorescent pigments and/or glitter particles are added to the mix. These color progressions can then no longer be reproduced by thermosublimization printers because the fluorescent pigments and/or glitter particles react to the internal flash of the smartphone.

One way to apply the forgery-proof color imprint to an object, as mentioned above, is to apply ink droplets to the object next to each other or at least partially overlapping and subsequently to suitably mix and distribute these ink droplets. A suitable ink droplet system must be provided for this purpose. Instead of letting ink droplets drip onto the object, such as a label, a very good way is to apply the coloring compounds onto a suitable substrate using a small spray gun, e.g. an airbrush gun. First, the airbrush gun is used to apply at least two different inks in a “supersaturated” form next to each other or at least partially overlapping to the label. The term “supersaturated”, as used herein, is to mean that such a quantity of coloring compound is applied using the airbrush gun that this ink can be arbitrarily and thus randomly distributed thereafter on its substrate. This can be done using a suitable air nozzle, which may also be the airbrush gun that is no longer supplied with ink and which is just aimed at the still wet ink to distribute it in a random manner. This creates a mixed area of the previously applied coloring compounds about at the center of the color imprint, and a spray area towards the edges of each coloring compounds where just a few spatters of the one or the other coloring compounds remain on the substrate.

In a further development of the invention, the forgery-proof object and particularly the forgery-proof marking applied to a label is completely or at least partially stored in a database for analysis during a later identification of the object or label. This storage of an image file of the forgery-proof object or forgery-proof marking is excellently suited for enabling later tracking of the forgery-proof object.

The invention will be explained in more detail below with reference to an exemplary embodiment of a forgery-proof label. However, the invention is not limited to producing and providing a forgery-proof label. Instead, a forgery-proof marking according to the invention can also be applied to any other object, e.g. products (e.g. a soccer ball), spare parts in vehicles, etc. It is assumed merely for illustration purposes that a forgery-proof label is provided. Wherein:

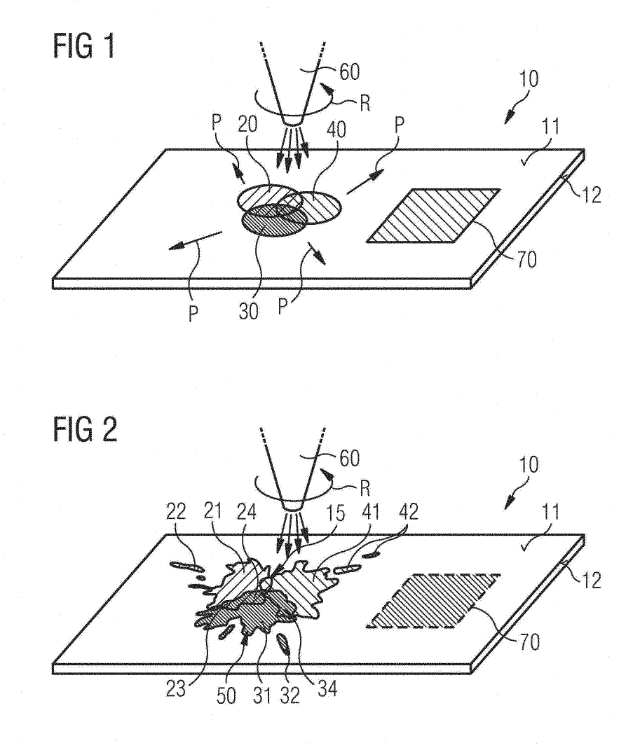

FIG. 1 shows a label according to the invention to which various ink droplets were applied in a first process step,

FIG. 2 shows the label of FIG. 1 in which the ink droplets are distributed among each other using an air nozzle,

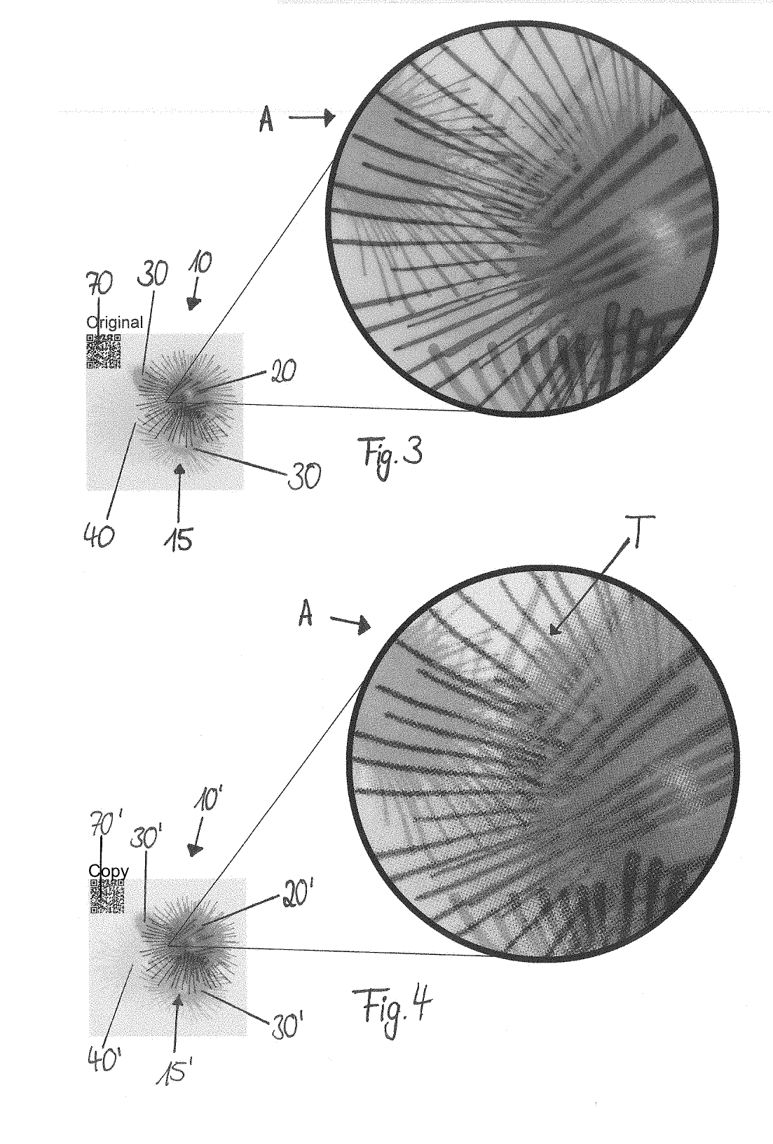

FIG. 3 shows a forgery-proof label according to the invention in black and white and in color, and

FIG. 4 shows a forged label in comparison to the label of FIG. 3, likewise in black and white and in color

In the figures below, like reference numbers identify like components having the same meaning, unless indicated otherwise.

FIG. 1 shows a schematic perspective view of an object 10, which herein is a flat label having a first upper main surface 11 and a lower main surface 12. This label 10 may for example consist of paper, a cardboard, a film or a textile material for being attached to a product, such as a car spare part, a toy, such as a soccer ball or the like.

Multiple coloring compounds are applied to the upper main surface 11, here in the form of ink droplets 20, 30, 40. The ink droplets 20, 30, 40 can in principle have any color, but preferably have one of the solid colors red, blue, or yellow. The ink droplets 20, 30, 40 may also have other colors. The individual color droplets can also have just one color, e.g. red. In the simplest case, a single ink droplet 20 is applied to the main surface 11.

As shown in FIG. 1, the ink droplets 20, 30, 40 partially overlap when being applied to the upper main surface 11 of the label 10. The ink droplets 20, 30, 40 can also be applied in a completely overlapping manner to the flat main surface 11. In addition, the ink droplets 20, 30, 40 can be applied next to each other at a spacing from each other to the main area 11. Ideally, the ink droplets 20, 30, 40 overlap at least partially. After applying these ink droplets 20, 30, 40 to the main area 11 and before they have dried, these ink droplets 20, 30, 40 are at least partially intermixed and distributed. As shown in FIG. 1, an air nozzle 60 may be used for this purpose, which blows onto the ink droplets 20, 30, 40 from above at some distance and ensures their distribution. To effect an optimum distribution, this air nozzle 60 may also rotate, as indicated by the rotational arrow R in FIG. 1. The air flow generated by the air nozzle 60 is aimed at the previously applied ink droplets 20, 30, 40 and distributes them in accordance with the air flow arrows P outlined in FIG. 1.

FIG. 2 shows the result of this color mixing and distributing of the ink droplets 20, 30, 40. The three ink droplets 20, 30, 40 intermix at their approximate centers. In the edge region of each of the ink droplets 20, 30, 40, the ink of the ink droplets 20, 30, 40 spreads out in a radial and spattering manner. After the air nozzle 60 is removed or the air flow switched off and the resulting color imprint 15 has dried, there will be a smudged and blended color imprint, as outlined in FIG. 2. This resulting color imprint is then the “fingerprint” of the label 10, as it were.

This “fingerprint” is characterized by areas in which the ink droplets 20, 30, 40 are randomly intermixed and/or have run into each other. In addition, the “fingerprint” has colored ink spatters and jets distributed via the air flow P, which also make the “fingerprint” unique and forgery-proof. These ink spatters or jets have a different brightness profile. The smudged area of the ink droplet 20 is identified by the reference symbol 21 in FIG. 2. The smudged area of the ink droplet 30 is identified by the reference symbol 31, and the smudged area of the ink droplet 40 is identified by the reference symbol 41. In addition, the “fingerprint” features sporadic ink spatters due to the action of the air flow. These are identified in FIG. 2 by the reference symbols 22, 32, and 24. The smudged areas 21, 31, 24 and the ink spatters 22, 32, 24 are typically rather remote from the center of the fingerprint. In the approximate center of the fingerprint, the ink droplets 20, 30, 40 are intermixed in a random manner by the action of the air flow. In FIG. 2, these intermixed areas are identified by the reference symbols 23, 34, and 24. The reference symbol 23 identifies an area in which the ink droplet 20 is intermixed with the ink droplet 30. The reference symbol 34 identifies an area in which the ink droplet 30 is intermixed with the ink droplet 40, and the reference symbol 24 identifies an area in which the ink droplet 40 is intermixed with the ink droplet 20.

It is comprehensible that, even if the process of dripping the ink droplets 20, 30, 40 onto the main area 11 of the label 10 and subsequent swirling of the ink droplets 20, 30, 40 by the air nozzle 60 is repeated, it will never be possible to produce an identical fingerprint. This exactly is the rationale of the invention. Mixed colors will occur, particularly in the mixed areas 23, 24, and 34, which also are not mass-reproducible because such mass-reproduced copies made using printers or copiers always require a striation of the mixed colors.

As additionally indicated in the FIGS. 1 and 2, a coding 70 can be placed next to the fingerprint on the main area 11 of the label 10. This coding 70 can contain different data, such as product-specific data, data about the manufacturing of the fingerprint, quality information, etc. In the exemplary embodiment of FIGS. 1 and 2 shown, a square field is applied next to the imprint 15 or fingerprint, which may for example be a barcode or a QR code.

FIG. 3 shows a detailed exemplary embodiment of an original label 10 with a coding 70. The reference symbols already known are used again for the same components. For reasons of clarity, a colored figure of the label 10 is enclosed in the application documents in addition to a black and white presentation to demonstrate the idea the present invention is based on and particularly the comparison to a forged label 10′, as shown in FIG. 4. FIG. 3 shows an enlarged excerpt A of the original label 10 to make each detail of the original label 10 well visible.

The color imprint 15 or fingerprint, respectively, is in the exemplary embodiment shown implemented by four ink droplets 10, 20, 30, which are applied next to each other to the label 10. As shown in FIG. 3, two red ink droplets 30 are applied next to each other to the label 10. In this exemplary embodiment, the ink droplets 20, 30, 40 are applied to the label 10 in supersaturated form using an airbrush gun. Supersaturated means in this context that such a quantity of coloring compound is applied for each ink droplets 20, 30, 40 that this ink can be distributed in a subsequent process, for example using an air nozzle of the airbrush gun. After applying the ink droplets 20, 30, 40, it is preferred that an air nozzle is aimed at the centers of the previously applied ink droplets 20, 30, 40, such that the still wet ink of the ink droplets 20, 30, 40 can run radially outwards in a star shape, as shown.

In this manner, a radial color area is produced for each of the applied ink droplets 20, 30, 40, wherein the star-shaped rays partially run into each other and result in a mixed color. The ink droplets 20, 30, 40 also partially run into each other at the approximate center of the color imprint 15.

As FIG. 3 shows, a coding 70 explained above in conjunction with the FIGS. 1 and 2 is also imprinted onto the label 10 next to the color imprint 15. As mentioned, FIG. 3 shows the original of the color imprint 15.

If one tries to reproduce the original label 10, for example using a copier or a printer, this can only be done by accepting clear deviations from the original label 10 or the original color imprint 15, which are identifiable by everyone. FIG. 4 clearly shows this.

FIG. 4 shows a forged label 10′. This reproduced or forged label 10′ also has a bar coding 70′ in the top left corner of the reproduced label 10′. At first glance, a color imprint 15′ which is very similar to the original label 10 can be seen in FIG. 4. But if one takes a closer look at the detail A shown enlarged in FIG. 4—like in FIG. 3—it becomes immediately evident that this detail A on the one hand has a striation T which is not present in this manner in the original label 10. It is also noticeable that the radial distribution of the ink droplets 20, 30, 40 and the mixed colors are much more blurred than in the original label 10. This is precisely how the forged object 10′, which may for example be a forged label 10′, can easily be identified. A forged marking on the label 10′ is detectable based on these differences, namely the striated representation of the mixed colors and the blurred details, particularly the radial ink distributions.

The method for identifying an original marking according to the present invention will once again be explained. It is assumed that the original marking, which is shown in FIG. 3, is stored at least in sections in an image file, preferably in a high-resolution image file. If the marking according to FIG. 3 is captured and stored using a mobile terminal, such as a smartphone, it will be found when comparing this image taken by the mobile terminal with the image stored in the image file that the images match, with the proviso that the resolution of the previously stored image of the image file is about the same as the resolution at which the mobile terminal has captured the marking. If the resolution is slightly different, the will be a slight difference, which will however be rated as a high degree of convergence. It will therefore be recognized that the marking photographed using the mobile terminal is an original marking.

If however the mobile terminal, e.g. the smartphone, captures the marking produced by a printing method according to FIG. 4, that is, captures a forged marking as defined by the present invention, it will be found due to the rough striation of the marking that there is actually no match with the image file of the original marking, even if said marking appeared to be an identical marking when viewed with the naked eye. A user of the mobile terminal can easily determine this if he or she views the image taken with the mobile terminal, i.e. the smartphone, at a high zoom level. Because, if enlarged, the striation due to the printing method will easily become visible. The method for identifying if a marking is an original or a forged marking can be automated when electronically comparing the image file of an original marking stored in a storage device to the image taken by the mobile terminal of the end customer. The image of the marking to be checked taken by the end user just has to be electronically compared to the original image file. This can easily be implemented as part of a so-called app.

### LIST OF REFERENCE SYMBOLS

10 Forgery-proof object, marking
11 First main surface
12 Second main surface
15 Imprint, “fingerprint”
20 Coloring compound, particularly ink droplet
21 Smudged area
22 Ink spatters
23 Mixed area of 20 and 30
24 Mixed area of 40 and 20
30 Color compound, particularly ink droplet
31 Smudged area
32 Ink spatters
34 Mixed area
40 Color compound, particularly ink droplet
41 Smudged area
42 Ink spatters
44 Mixed area
60 Air nozzle
70 Coding
10′ Forged object, particularly label
11′ First main area of the forged object
12′ Second main area of the forged object
21′ Smudged area of the forged object
22′ Ink spatters of the forged object
31′ Smudged area of the forged object
32′ Ink spatters of the forged object
34 Forged object
41′ Smudged area of the forged object
42′ Ink spatters of the forged object
44′ Mixed area of the forged object
A Excerpt
P Arrow for air flow
R Direction of rotation
T Striation

1. A mass-producible, forgery-proof marking comprising:
an object;
a multicolored imprint, located on the object, of ink droplets, each of which comprises a different color and each of which, in a random manner, at least partially intermix with one another and are smudged, blown or swirled together.

2. The mass-producible, forgery-proof marking according to claim 1,
wherein the ink droplets are formed of pigmented inks.

3. The mass-producible, forgery-proof marking according to claim 2,
wherein two ink droplets have a different color.

4. The mass-producible, forgery-proof marking according to claim 1,
wherein at least three coloring compounds having different colors are applied to the object.

5. The mass-producible, forgery-proof marking according to claim 1,
wherein the random intermixing and smudging of the ink droplets is produced by air flow swirling.

6. The mass-producible, forgery-proof marking according to claim 1,
wherein at least one of the ink droplets contains fluorescent pigments, glitter particles, or both fluorescent pigments and glitter particles.

7. The mass-producible, forgery-proof marking according to claim 1,
wherein the object is a paper, cardboard, film, a textile material, a label, or spare part.

8. The mass-producible, forgery-proof marking according to claim 1,
wherein the object comprises, in addition to the multicolor imprint, a coding in which data is stored.

9. The mass-producible, forgery-proof marking according to claim 8,
wherein the coding is disposed on a main surface of the object to which the multicolor imprint is also applied.

10. The mass-producible, forgery-proof marking according to claim 1,
wherein the marking is completely or at least partially stored in a database to be analyzed during a later identification of the object.

11. A method for mass-producing a forgery-proof marking, comprising:
providing an object having a main surface,
applying an ink droplet to the main surface of the object in supersaturated form,
distributing the ink droplet, as long as it has not dried, via an air nozzle to form a distributed imprint,
drying the distributed imprint.

12. The method according to claim 11,
wherein the air nozzle rotates.

13. The method according to claim 11,
wherein applying an ink droplet to the main surface of the object in supersaturated form comprises applying at least two ink droplets at a spacing from each other.

14. The method according to claim 11,
wherein applying an ink droplet to the main surface of the object in supersaturated form comprises applying at least two ink droplets in at least a partially overlapping manner.

15. The method according to claim 11,
wherein the ink droplet is applied to the object using airbrushing technology.

16. A method for identifying an anti-forgery marking according to claim 11 comprising:
optically detecting a reference marking and electronically storing the reference marking in a database,
optically detecting a marking to be identified using a mobile terminal and electronically storing an image of the marking to be identified,
comparing the image captured by the mobile terminal to the reference marking stored in the database,
determining that an original marking was captured, if
a) the image captured using the mobile terminal does not comprise copy-related striation, and
b) matches or largely matches the image stored in the database, and
determining that a forged marking is present if at least one of a) and b) is not met.

17. The method according to claim 16,
wherein the method is performed using an app in that a user photographs a marking to be identified and sends it using the mobile terminal of a controller, which is connected to a database, and the controller performs the comparison and sends a message which indicates whether the marking optically captured by the mobile terminal is an original marking or a forged marking.

18. The method according to claim 16 or 17,
wherein the stored images are stored in the form of an identifier.
